(19) United States
(12) Patent Application Publication
(10) Pub. No.: US 2011/0304460 A1
(43) Pub. Date: Dec. 15, 2011

(54) SYSTEM AND METHOD FOR MONITORING GOLF CLUB INVENTORY

(76) Inventors: Ravisankar KEECHERIL, West Palm Beach, FL (US); Joseph Taverrite, Royal Palm Beach, FL (US); Michael Turdo, West Palm Beach, FL (US); David M. Boshko, West Palm Beach, FL (US)

(21) Appl. No.: 12/797,437

(22) Filed: Jun. 9, 2010

(51) Int. Cl. G08B 13/14

(52) U.S. Cl. 340/572.1

(57) ABSTRACT

A system for monitoring an inventory of golf clubs includes a plurality of golf clubs with wireless transceivers and a monitor that transmits a first interrogation signal to the plurality of wireless transceivers, the first interrogation signal being an invitation for each of the plurality of wireless transceivers to respond with a signal that indicates each transceiver's unique identification code. The monitor interprets each of the response signals received to determine the unique identification code within each signal, compares the set of expected identification codes stored in memory to each unique identification code received at the receiver, determines an absence of reception of at least one unique identification code within the set of expected identification codes, causes the transmitter to transmit a second interrogation signal to at least a one of the plurality of transceivers having the at least one determined absent unique identification code, the second interrogation signal being an invitation for the transceiver having the determined absent unique identification code to respond with a signal that indicates the at least one determined absent unique identification code, determines a continued absence at the receiver of the at least one determined absent unique identification code, and activates a missing club indicator if an amount of time between the determining the absence and the determining the continued absence exceeds a predetermined amount.

### BACKGROUND OF THE INVENTION

1. Field of the Invention

The present invention relates generally to golf-club loss prevention and, more particularly, relates to a system for and method of monitoring an inventory of golf clubs within a golf bag and alerting a user upon detection of an unintended separation of one or more clubs from the group of clubs.

2. Description of the Related Art

The game of golf has become one of, if not the, most participated sports in the world. In 2005, Golf Digest magazine listed the countries with the most golf courses per capita, which, from greatest to least, were: Scotland, New Zealand, Australia, Republic of Ireland, Northern Ireland, Canada, Wales, United States, Sweden, and England. It is estimated that in the United States alone, at least 4.6 million people play golf 25 times or more per year.

Golf “clubs” are used to hit a golf ball. Each club includes a shaft with a “grip” on the top end and a club head on the bottom. A golfer typically carries a bag that holds a “set” of clubs. The set generally includes a series of what are referred to as “woods” and “irons,” each differing from the others in some aspect. The woods, compared to the irons, have relatively long shafts, large heads and are used for long-distance fairway shots. For instance, the “driver” is one of the woods and is the longest club with the largest head for striking the ball. “Irons” are the next shorter in length and are the most numerous and versatile class used for a wide variety of shots. Hybrid clubs, which embody characteristics of both woods and irons, are increasingly being used in preference to long irons in many places because they are easier for the average golfer to use. Finally, “putters” are used for short distance shots to roll the ball across the green into the cup.

During play, the golfer's ball often lands in remote locations, such as in the bushes, in a bunker, on the far side of the green, or many other locations, which are usually not intended. While traveling the golf course, golfers either carry the bag of clubs on their shoulder or attach it to a golf call, which is then driven from shot location to shot location. When the ball lands in a remote location, however, it is more convenient to leave the bag behind and carry several potentially-suitable clubs to the spot. Once the proper club is selected, typically the other clubs are laid on the ground while the golfer swings. Unfortunately, these extra clubs are often inadvertently left behind when the golfer returns to the cart. In fact, the golfer may not realize that a club is missing until much later, if at all. Accordingly, it often becomes necessary for the golfer to backtrack a significant distance to retrieve the abandoned club. This backtracking contributes to large interruptions in the game play and can lead to stress and embarrassment for the golfer. In some cases, the abandoned club may have already been retrieved by another golfer, leaving the absent-minded golfer unable to use the abandoned club for the remainder of the round. In other cases, the club is never again located.

Several prior art techniques for detecting golf club removal from a bag or separation from the golfer have been developed. Most of the suggested solutions require special switches attached to club tubes within the golf bag, special detectors, such as movement or light, on each club, power-consuming constant communication from the clubs, and others. Each of these solutions is prone to component failures and/or false or inaccurate readings and corresponding false alarms.

Therefore, a need exists to overcome the problems associated with the prior art, for example, those discussed above.

### SUMMARY OF THE INVENTION

Briefly, in accordance with exemplary embodiments of the present invention, a golf-club tracking system and method is disclosed. The invention includes a plurality of wireless transceivers, each wireless transceiver being attached to a golf club, and a monitor able to be coupled to a golf bag or a person. Advantageously, the invention provides a method of monitoring an inventory of golf clubs that includes the step of transmitting a first interrogation signal from a transmitter to a plurality of wireless transceivers, each transceiver coupled to one of a corresponding plurality of golf clubs, the first interrogation signal being an invitation for each of the plurality of wireless transceivers to respond with a signal that indicates an identification code uniquely assigned to each transceiver. Further steps include receiving a plurality of response signals with a receiver, each response signal including the unique identification code assigned to the responding transceiver, interpreting each of the plurality of response signals received at the receiver to identify the unique identification code within each signal, comparing a set of expected identification codes stored in a memory to each unique identification code received at the receiver, determining an absence of reception of at least one unique identification code within the set of expected identification codes, causing the transmitter to transmit a second interrogation signal to at least a one of the plurality of transceivers having the at least one determined absent unique identification code, the second interrogation signal being an invitation for the at least one of the plurality of transceivers having the determined absent unique identification code to respond with a signal that indicates the at least one determined absent unique identification code, and, in response to determining a continued absence of the at least one determined absent unique identification code and determining an elapsed time between the determining an absence and the determining a continued absence exceeds a predetermined amount, activating a missing club indicator.

With the foregoing and other objects in view, there is provided, in accordance with the invention, a system for monitoring an inventory of golf clubs. The system includes a plurality of wireless transceivers, each wireless transceiver being attachable to a golf club and having a communicable unique identification code. Also included is a monitor couplable to a golf bag, the monitor having a transmitter, a receiver, a missing club indicator, a memory having a set of expected identification codes stored therein, and a processor communicatively coupled to the transmitter, the receiver, the missing club indicator, and the memory. The processor is operable to cause the transmitter to transmit a first interrogation signal to the plurality of wireless transceivers, the first interrogation signal being an invitation for each of the plurality of wireless transceivers to respond with a signal that indicates each transceiver's unique identification code, to interpret each of the response signals received at the receiver to determine the unique identification code within each signal, to compare the set of expected identification codes stored in the memory to each unique identification code received at the receiver, to determine an absence of reception of at least one unique identification code within the set of expected identification codes, to cause the transmitter to transmit a second interrogation signal to at least a one of the plurality of transceivers having the at least one determined absent unique identification code, the second interrogation signal being an invitation for the transceiver having the determined absent unique identification code to respond with a signal that indicates the at least one determined absent unique identification code, to determine a continued absence at the receiver of the at least one determined absent unique identification code, and to activate the missing club indicator if an amount of time between the determining the absence and the determining the continued absence exceeds a predetermined amount.

The present invention, according to several embodiments, allows the processor to cause the transmitter to transmit an inventory signal to the plurality of wireless transceivers, the inventory signal being an invitation for the plurality of wireless transceivers to respond with a signal that indicates each transceiver's unique identification code, to cause the receiver to receive at least one response to the inventory signal, and to create the set of expected identification codes by storing in the memory each unique identifier code indicated by each of the at least one responses to the inventory signal.

With the objects of the invention in view, the second interrogation signal is transmitted at a power level greater than a power level of the first interrogation signal.

In accordance with another feature of the invention, the processor is further operable to cause the transmitter to transmit at least one intermediate interrogation signal between the transmission of the first interrogation signal and the transmission of the second interrogation signal.

In accordance with another feature of the invention, the monitor further comprises a first antenna, a second antenna, and a switch selectively coupling the first antenna between the receiver and the transmitter, the selective coupling being non-communal with a coupling of the second antenna.

In accordance with a further feature of the invention, there is provided a plurality of housings adapted for secured coupling to a golf club, each housing at least partially surrounding one of the plurality of wireless transceivers.

In accordance with an added feature of the invention, the secured coupling is to a grip end of the golf club.

In accordance with an additional feature of the invention, processor is operable to determine a presence of reception of all unique identification codes within the set of expected identification codes and place the monitor into a low-power state.

In accordance with yet another feature of the invention, the monitor includes a motion detector communicatively coupled to the processor, and the processor is further operable to activate the missing club indicator upon receiving a signal from the motion detector indicating the presence of movement of the monitor.

In accordance with yet a further feature of the invention, the missing club indicator is physically separate from and in wireless communication with the monitor.

In accordance with yet an added feature, the invention includes a display operable to display an identification of a missing club and the display is physically separate from and in wireless communication with the monitor.

With the foregoing and other objects in view, there is provided, in accordance with the invention, a monitor for monitoring an inventory of golf clubs. The monitor includes a transceiver, a missing club indicator, a memory having a set of expected identification codes stored therein, and a processor. The processor is able to cause the transceiver to transmit a first interrogation signal to a plurality of wireless transceivers, the first interrogation signal being an invitation for each of the plurality of wireless transceivers to respond with a signal that indicates each transceiver's unique identification code, to interpret each of the response signals received at the transceiver to determine the unique identification code within each signal, to compare the set of expected identification codes stored in the memory to each unique identification code received at the receiver, to determine an absence of reception of at least one unique identification code within the set of expected identification codes, to cause the transceiver to transmit a second interrogation signal to at least a one of the plurality of transceivers having the at least one determined absent unique identification code, the second interrogation signal being an invitation for the transceiver having the determined absent unique identification code to respond with a signal that indicates the at least one determined absent unique identification code, to determine a continued absence at the transceiver of the at least one determined absent unique identification code, and to activate the missing club indicator if an amount of time between the determining the absence and the determining the continued absence exceeds a predetermined amount.

In accordance with a concomitant feature of the invention, the monitor further includes a motion detector communicatively coupled to the processor, and the processor is further able to activate the missing club indicator upon receiving a signal from the motion detector indicating the presence of movement of the monitor.

Although the invention is illustrated and described herein as embodied in a system and method for monitoring golf club inventory with a plurality of wireless transceivers, each wireless transceiver being attached to a golf club, and a monitor couplable to a golf bag or a person, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

While the specification concludes with claims defining the features of the invention that are regarded as novel, it is believed that the invention will be better understood from a consideration of the following description in conjunction with the drawing figures, in which like reference numerals are carried forward. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. The figures of the drawings are not drawn to scale.

### DETAILED DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

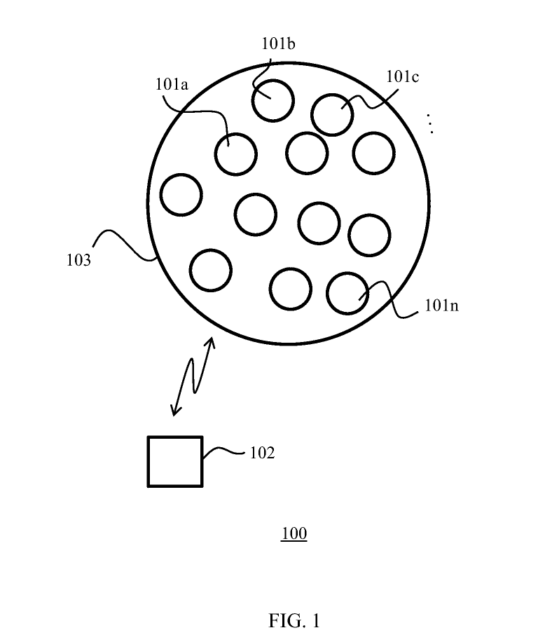

FIG. 1 is a diagram of a plurality of wireless transceivers each attached to one of plurality of a golf clubs being held within a golf bag and in wireless communication with a golf-club monitor, in accordance with an exemplary embodiment of the present invention.

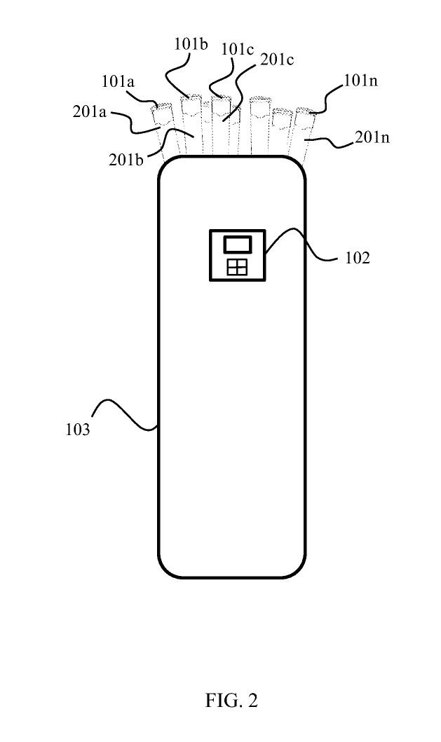

FIG. 2 is an elevational side view a golf bag holding a plurality of wireless transceivers each attached to one of plurality of a golf clubs being held within a golf bag with a golf-club monitor attached thereto, in accordance with an exemplary embodiment of the present invention.

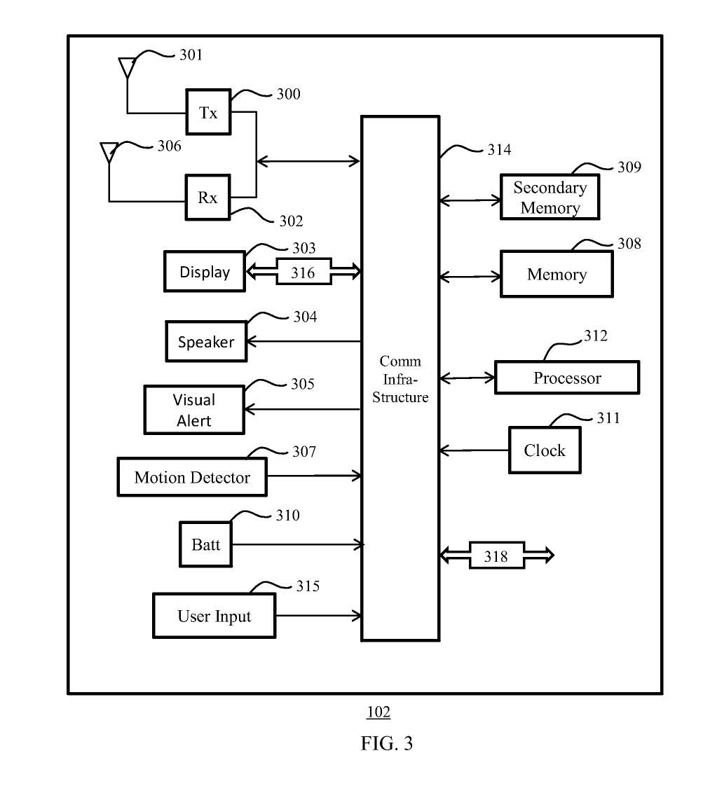

FIG. 3 is a block circuit diagram of the golf-club monitor of FIG. 2, in accordance with an exemplary embodiment of the present invention.

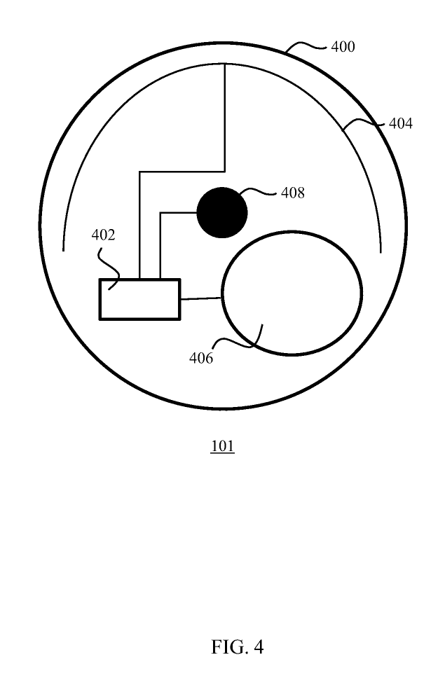

FIG. 4 is a block circuit diagram of one of the wireless transceivers of FIG. 2, in accordance with an exemplary embodiment of the present invention.

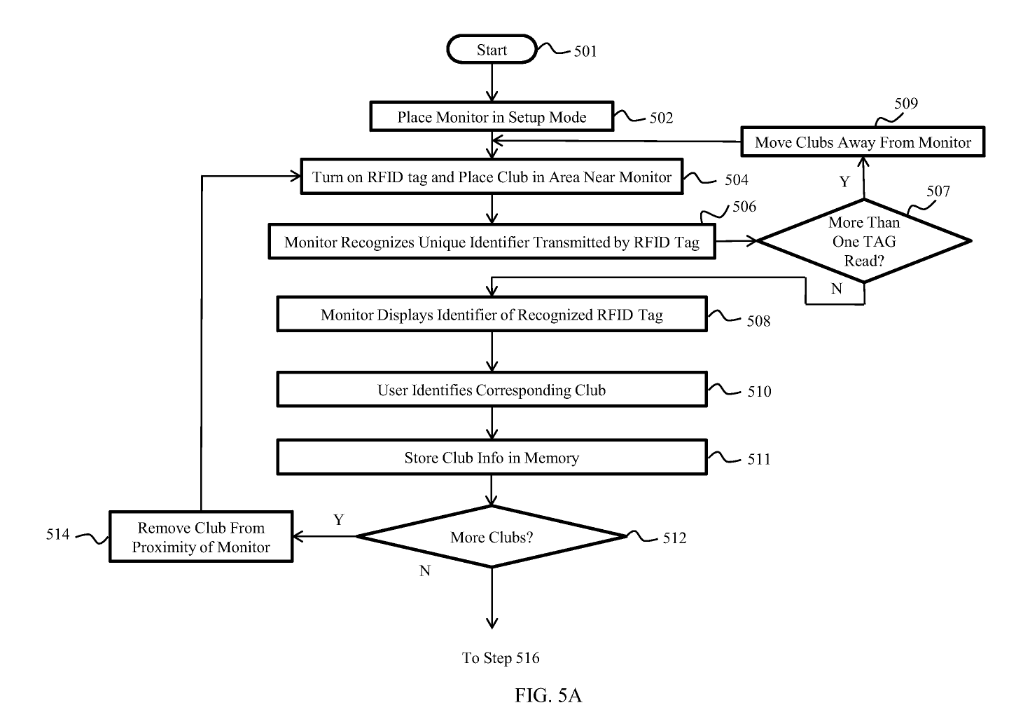

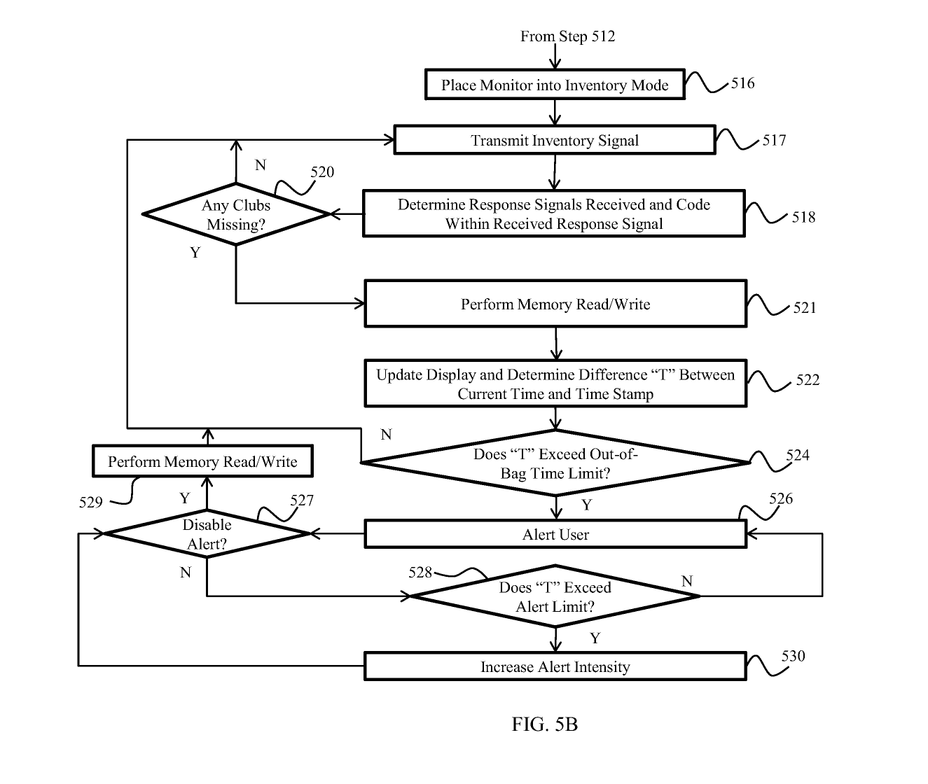

FIG. 5A is a process flow diagram of a set up process for registering golf clubs with the monitor, in accordance with an exemplary embodiment of the present invention.

FIG. 5B is a process flow diagram of a golf club monitoring method, in accordance with an exemplary embodiment of the present invention.

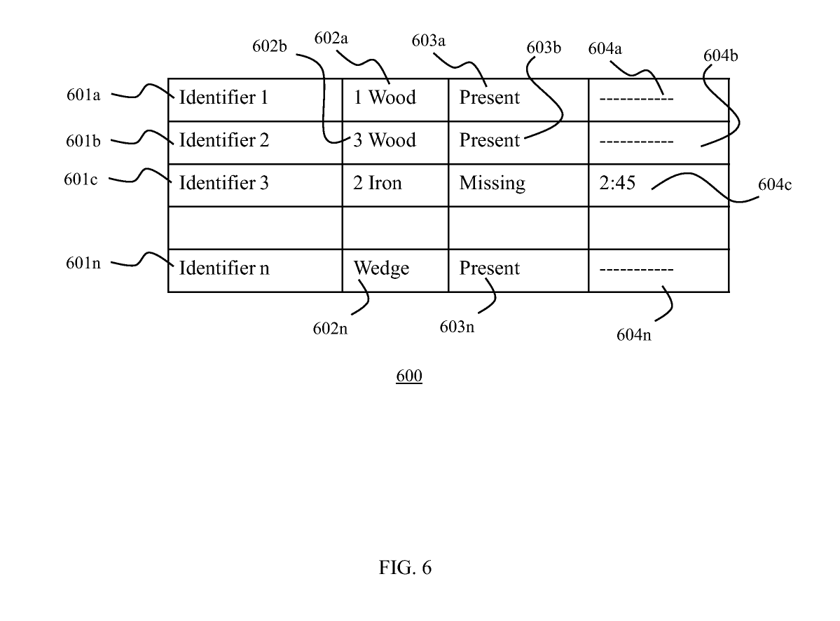

FIG. 6 is a representation of an exemplary storage area holding golf-club tracking information within memory, in accordance with an exemplary embodiment of the present invention.

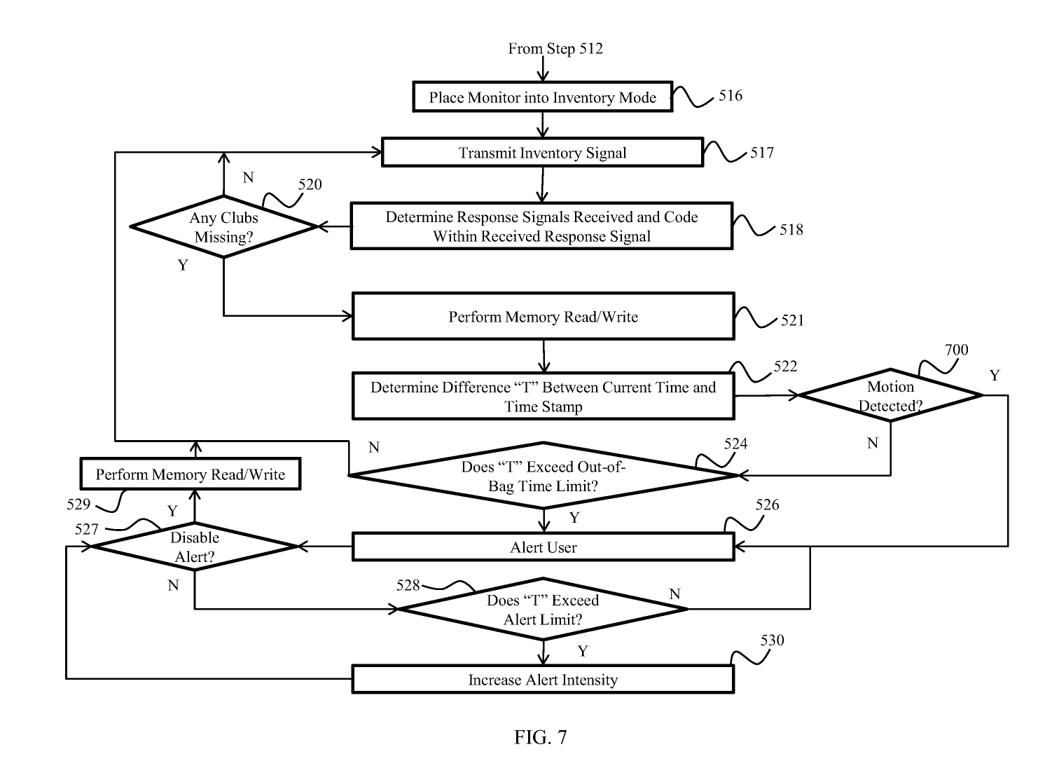

FIG. 7 is a process flow diagram of a golf club monitoring method utilizing a motion detector, in accordance with an exemplary embodiment of the present invention.

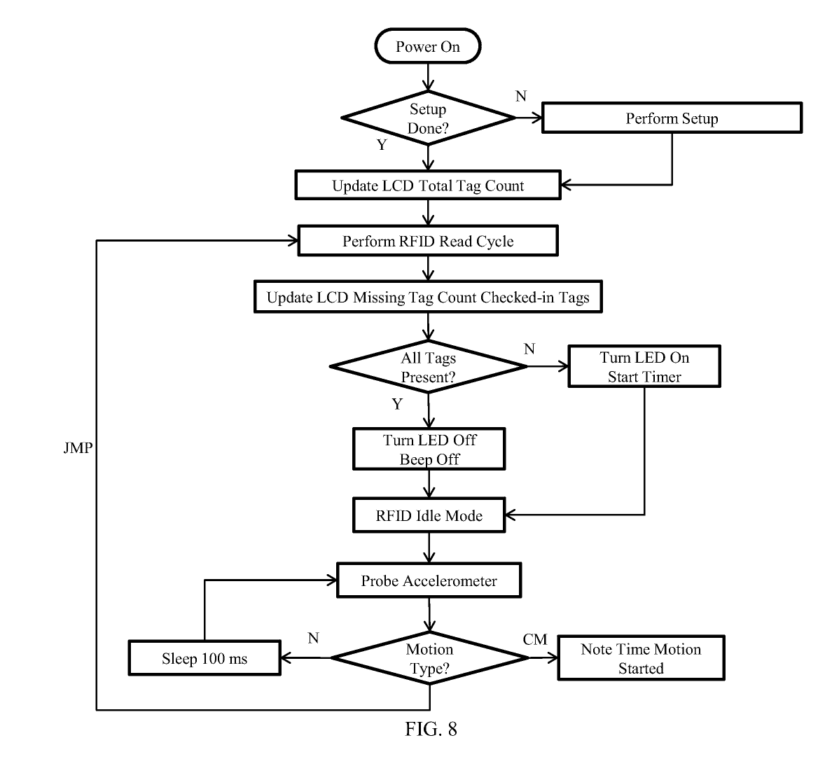

FIG. 8 is a process flow diagram of a golf club monitoring method utilizing a motion detector, in accordance with an exemplary embodiment of the present invention.

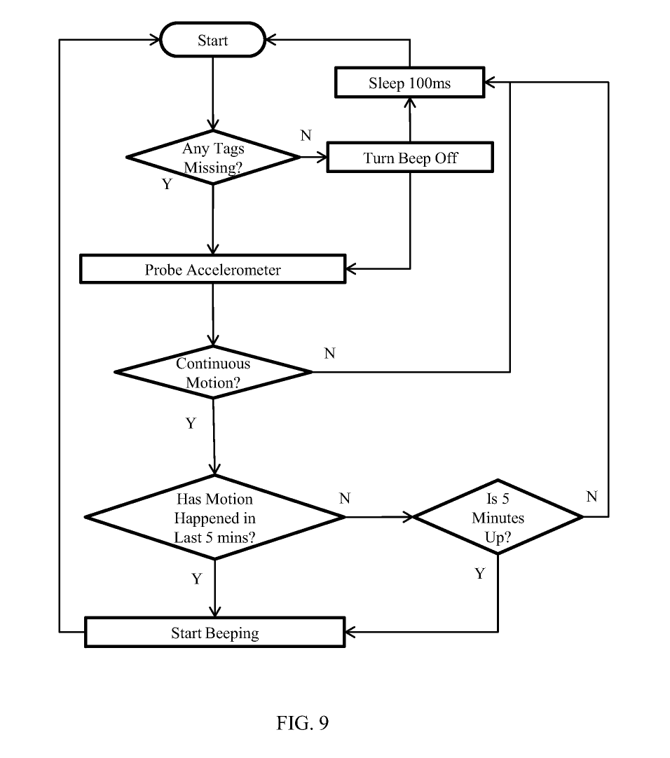

FIG. 9 is a process flow diagram of a golf club monitoring method utilizing a motion detector, in accordance with an exemplary embodiment of the present invention.

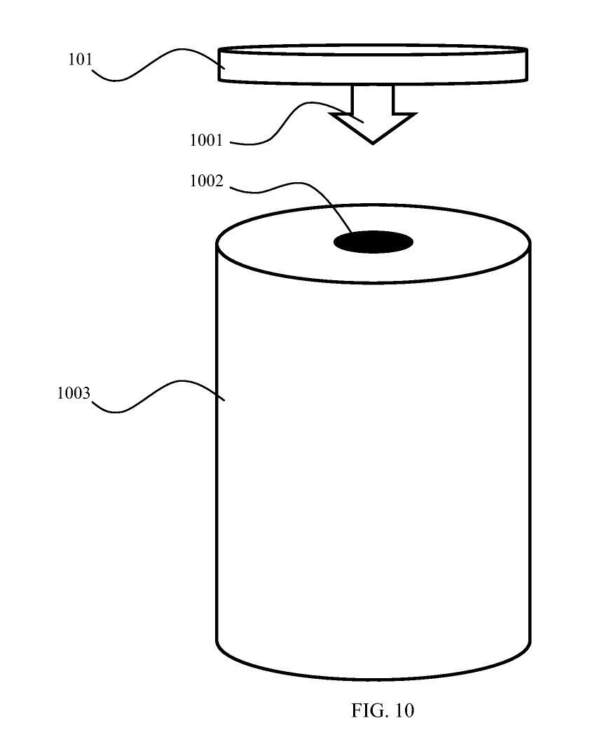

FIG. 10 is an elevational view of an RFID tag with an anchor suitable for securely mating the RFID tag with an upper portion of a golf club grip, in accordance with an exemplary embodiment of the present invention.

### DETAILED DESCRIPTION OF THE EMBODIMENTS

It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

Before the present invention is disclosed and described, it is to be understood that the terminology used herein is for the purpose of describing particular embodiments only and is not intended to be limiting. In this document, the terms “a” or “an”, as used herein, are defined as one or more than one. The term “plurality,” as used herein, is defined as two or more than two. The terms “another,” “additional,” and “further,” as used herein, are defined as at least a second or more. The terms “including” and/or “having,” as used herein, are defined as comprising (i.e., open language). The term “coupled,” as used herein, is defined as connected, although not necessarily directly, and not necessarily mechanically. Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that embodiments of the invention described herein may be comprised of one or more conventional processors and unique stored program instructions that control the one or more processors to implement, in conjunction with certain non-processor circuits and other elements, some, most, or all of the functions of ultrasonic cutting devices described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could also be used. Thus, methods and means for these functions have been described herein.

The terms “program,” “software application,” and the like as used herein, are defined as a sequence of instructions designed for execution on a computer system. A “program,” “computer program,” or “software application” may include an instruction, a subroutine, a function, a procedure, an object method, an object implementation, an executable application, an applet, a servlet, a source code, a compiled code, an interpreted code, an object code, a shared library/dynamic load library and/or other sequence of instructions designed for execution on a computer system.

The present invention, according to one embodiment, overcomes problems with the prior art by providing a golf club monitoring system that identifies one or more golf clubs to be tracked and monitors the one or more clubs to determine when the one or more clubs has/have been removed from a golf bag. The inventive system periodically, or upon the occurrence of an event, such as a detected movement, searches for an indicator that the club has been replaced within the bag and, depending on the presence of the indicator, can either change states or continue monitoring for a replacement of the club within the bag. The changing of states can be a return to an inventory “accounted for” status or an alert that communicates to a user that one or more clubs has not been returned to the golf bag.

Golf Club Tracking System

Described now is an exemplary golf-club tracking system according to an embodiment of the present invention. Referring to FIG. 1, a golf-club tracking system 100 includes a monitor 102 and a plurality of golf-club-tracking Radio Frequency Identification (RFID) tags 101a-n. The monitor 102 is able to wirelessly communicate with the plurality of RFID tags 101a-n and, in particular, is able to determine the presence of each of the RFID tags 101a-n within a predetermined physical range from the monitor 102.

The exemplary monitor 102 is shown in FIG. 2 as being coupled to a golf bag 103. The term “golf bag,” as used herein, generally refers to any structure that is able to transport golf clubs. Traditionally, golf bags are provided in a generally cylindrical shape (such as golf bag 103 shown in FIGS. 1 and 2) with multiple pockets, which are designed for carrying various equipment and supplies pertinent to a round of golf. In addition, golf bags generally have both a hand strap and shoulder strap for carrying, and sometimes have retractable legs that allow the bag to stand upright when at rest. Therefore, with reference to the inventive monitor 102, the term “couplable to a golf bag” is intended to mean any attachment to the golf bag at selectable locations or insertion within bag.

When the inventive monitor 102 is shown or described as being used in conjunction with a golf bag 103, the golf bag 103 is not limited to any particular shape, size, or material. Golf bags can be carried, pulled on a two-wheel pull cart, or harnessed to a motorized golf cart during play. Embodiments of the invention envision physically coupling the monitor 102 to a pull cart, a motorized cart, the golfer himself, as well as other structures and locations that are not physically coupled to the golf bag 103.

The golf bag 103 is shown in FIG. 2 as housing a plurality of golf clubs 201a-n therewithin. Each of the golf clubs 201a-n supports a corresponding one of the RFID tags 101a-n, with each RFID tag 101a-n having a unique identifier that allows the monitor 102 to distinguish one RFID tag from the others. Although the invention is not so limited, the particular embodiment shown in FIG. 2 places the RFID tags 101a-n within, on, or otherwise attached to the hand-grip coupled to an end of a golf club's shaft. One exemplary embodiment of a mating configuration is shown in FIG. 10. FIG. 10 is an elevational view of one of the RFID tags 101, which includes an anchor 1001. The anchor 1001 can be inserted within a hole 1002 at one end of a golf grip 1003. Most golf grips feature this hole as a vent that allows the grip to be inserted onto a shaft of a club 201. The anchor 1001 is in no way limited to the shape shown in FIG. 10 and includes any shape that is suitable for securely mating the RFID tag 101 with an upper portion of a golf club grip 1003.

RFID tags are well known to those of ordinary skill in the art and generally include an antenna for transmitting and receiving radio-frequency (RF) signals as well as an integrated circuit for storing and processing information, modulating and demodulating the RF signal, and having a Globally Unique Identification Number (QUID), and other specialized functions.

The present invention is able to utilize active, passive, and battery assisted passive (BAP) RFID tags for communication with the monitor 102. Active RFID tags contain a battery and can transmit signals autonomously. Passive RFID tags have no battery and require an external source, e.g., a magnetic field, to provoke signal transmission. BAP RFID tags require an external source to wake up but have significant higher forward link capability providing greater range than passive RFID tags. The RFID tags 101a-n can all be of the same type or can be a combination of types. Throughout the specification, a reference to any one of the RFID tags 101a-n can include a reference to any of the above-mentioned types of RFID tags or any other similar tags, whether RFID or non-RFID, that perform the function of identifying itself through wireless signaling upon receiving a request to do so from an interrogating signal/device. In fact, the communication is not limited to radio frequency, but can also include IR signaling, audio signaling, ultrasonic communications, laser beams, and others.

FIG. 3 provides a high-level block diagram illustrating the various components of the monitor 102, which, according to one embodiment, includes a transmitter 300, a receiver 302, a display 303, a speaker 304, a visual alert 305, a clock 311, a motion detector 307, a memory 308, a power supply 310, a processor 312, a user input 315, and a communication infrastructure 314. The processor 312 is communicatively coupled to each of the components through the communication infrastructure 314 (e.g., a communications bus, cross-over bar, or network). Although various software and hardware embodiments are described in terms of this exemplary monitor system shown in FIG. 3, after reading this description, it will become apparent to a person of ordinary skill in the relevant art(s) how to implement the invention using other monitor systems and/or monitor architectures.

Transmitters are known to those of ordinary skill in the art. Transmitter 300 includes radiating element 301, e.g., an antenna, and is able to propagate electromagnetic signals through the medium, e.g., air around it. Although not illustrated, functions of the transmitter 300 can be enabled by an oscillator, a modulator, and one or more amplifiers. Receivers are also known to those of ordinary skill in the art. Receiver 302 includes a receiving element 306, e.g., an antenna, and is able to receive electromagnetic signals from the medium, e.g., air around it. Although not illustrated, functions of the receiver 302 can be enabled by an oscillator, a demodulator, and one or more amplifiers. According to an embodiment of the present invention, the transmitter 300 and receiver 302 can be combined within a single transceiver. Additionally, instead of two separate elements, the radiating elements 301 and 306 can be combined into one element that is shared between transmitter 300 and receiver 302. An exemplary frequency for RF communication between the monitor 102 and RFID tags 101a-n is 900 MHz and an exemplary power level is 1000 mW.

The display 303, the speaker 304, and the visual alert 305, together or separately, can serve as a missing club indicator and can communicate to a user the detection of a missing RFID tag from the plurality of RFID tags 101a-n. However, the missing club indicator is not limited to any specific component or group of components shown or described herein and can be any device able to indicate the monitor's 102 detection of a missing RFID tag 101a-n to a user. The operation of the missing club indicator 304 is described in greater detail below.

The monitor 102 can include a display interface 316 that forwards graphics, text, and other data from the communication infrastructure 314 for display on the display unit 303. The monitor 102 also includes a main memory 308, preferably random access memory (RAM), and may also include a secondary memory 309, such as a hard disk or removable storage. In one embodiment, the display unit 303 can be a separate unit, for example, a unit that attaches to the user's waist. In this embodiment, the display unit 303 can always remain attached to the user as he walks around, away from the cart/bag, and receives status updates wirelessly from the golf bag unit.

In alternative embodiments, the secondary memory 309 may include other similar communication hardware for allowing computer programs or other instructions to be loaded into the computer system. Such hardware may include, for example, a removable storage unit and an interface. Examples of such may include a removable memory chip (such as an EPROM, or PROM) and associated socket, and other removable storage units and interfaces which allow software and data to be transferred from the removable storage unit to the monitor 102.

In this document, the terms “computer program medium,” “computer usable medium,” and “computer readable medium” are used to generally refer to media such as main memory 308 and secondary memory 309, a removable storage drive, a hard disk, and signals. These computer program products are measures for providing software to the monitor, the programming steps within which being carried out by the processor 312. The computer readable medium allows the processor 312 to read data, instructions, messages or message packets, and other computer readable information from the computer readable medium.

Computer programs (also called computer control logic) are stored in main memory 308 and/or secondary memory 309. Computer programs may also be received via communications interface 318. Such computer programs, when executed, enable the computer system to perform the features of the present invention as discussed herein. In particular, the computer programs, when executed, enable the processor 312 to perform the features of the monitor 102. Accordingly, such computer programs represent controllers of the monitor 102.

FIG. 4 provides a detailed view of an exemplary RFID tag 101. According to one embodiment, the RFID tag 101 includes a housing structure 400 that supports an integrated circuit 402, antenna 404, a battery 406, and an off/on switch 408. Integrated circuit 402 is used to store and process information, modulate and demodulate radio-frequency (RF) signals, and to perform other specialized functions. Integrated circuits are known in the art. Antenna 404 is used to receive and transmit the RF signals. As previously stated, the battery 406 is optional and is particularly not present in the passive RFID tag embodiments where an external power source, e.g., a magnetic field, is used to provoke signal transmission. Of course, the present invention is not limited to any particular type or structure of RFID tag.

Setup Process

FIGS. 5A and 5B show a flow diagram of an exemplary process of monitoring an inventory of golf clubs according to the present invention. The flow starts at step 501 and moves directly to step 502 where the monitor 102 is placed into a setup mode, which allows the user to properly initialize the monitor 102 and ensure that the monitor 102 is tracking the correct golf clubs 201a-n. When the monitor 102 is first placed into the setup mode, it can operate at a lower one of its available power levels because it can be assumed that the RFID tags to be initialized will be in close proximity to the monitor 102, e.g., within about one meter. The display screen 303 instructs the user to keep all the RFID tags 101a-n at an appropriate distance away from the device. Then the user is instructed to bring one RFID tag at a time near the device.

In step 504, a first RFID tag 101a (attached to a first golf club 201a) is turned on (if the RFID tag is of the active type) and introduced to the proximity surrounding the monitor 102. Prior to step 504, all the RFID tags are kept away from the monitor 102, so that none of the tags are within communication range of the monitor 102. In step 506, the monitor 102 performs a read at a low power setting, so that only tags very near are read. In this step, the monitor 102 recognizes a unique identifier transmitted by the first RFID tag 101a. If the monitor 102 reads more than one tag, step 507, it alerts the user to move all the tags further away from the monitor in step 509 and returns to step 504.

If only one RFID tag 101 is read, the monitor 102 then, in step 508, displays on display 303 an identifier of the recognized RFID tag 101a. In step 510, using the user input 315, the user identifies which one of the set of clubs corresponds to the recognized RFID tag 101a and, in step 511, the user's input is stored in memory 308. The user input 315 can include multiple buttons, for example, a power button, a menu button, a mute button, and a navigation button with typical Up, Down, Left, Right, and Enter/Accept selections.

Other ways to recognize the RFID tags 101a-n exist as well. For instance, all RFID tags 101a-n may be read simultaneously and then, in a second step, the user can touch (bring the club within a few inches of) the monitor to input that club's name/type.

FIG. 6 is a diagrammatic representation of an exemplary storage area 600 within the memory 308. FIG. 6 shows a set of unique identifiers 601a-n stored in the memory 308 in a way that indicates the corresponding club type 602a-n associated with each identifier. FIG. 6 will be discussed in more detail below.

Returning now back to FIG. 5A, in step 512, the monitor 102 then asks the user if there are any further clubs to be registered. If the answer is yes, in step 514, the process moves back up to step 504 where a second RFID tag 101b (attached to a second golf club 201b) is turned on (if the RFID tag is of the active type) and introduced to the proximity surrounding the monitor 102. Steps 504 through 514 are repeated until all of the clubs 201 that require tracking have been registered, in which case, the process moves to step 516 shown in FIG. 5B.

Steps 500-514 are part of a stand-alone procedure, which need only be performed one time. The user performs these steps the first time he or she configures the monitor 102 and defines which of his or her set of clubs corresponds to which RFID tags 101a-n.

Inventory Mode

Once all of the clubs have been registered, the process moves to step 516. Steps 516-530 are steps that are performed on a day-to-day basis, whereas steps 500-514 can be, for the most part, more of a one-time procedure. In step 516, the monitor 102 is placed into “inventory” mode. Once in this mode, the monitor 102 transmits an inventory interrogation signal in step 517. Each interrogation signal is an invitation for each of the plurality of wireless transceivers 101a-n to respond with a signal that indicates each transceiver's unique identification code.

In step 518, the monitor 102 determines whether any response signals have been received from one or more of the plurality of RFID tags 101a-n and, through use of processor 312, determines the unique codes contained within each received signal. In step 520, a determination is made whether or not any clubs are missing. If no clubs are missing, the process moves back up to step 517. Subsequently, the device may switch into a temporary low-power mode until the next interrogation signal is sent.

If at least one club is determined to be missing in step 520, the process moves to step 521, where the processor 312 performs a memory read/write process. In the memory read/write step 521, the processor 312 writes to the memory storage area 600, shown in FIG. 6, and sets a status in each of the status boxes 603a-n for specific identifiers 601a-n as “present” if the unique identifier for that that club was received immediately subsequent to the interrogation step 516. In the read/write step 521, the processor 312 also writes to or reads the time-stamp fields 604a-n within the memory storage area 600. The time-stamp fields 604a-n are memory areas with data that indicates a time when a club 602a-n was first identified as missing, i.e., the RFID tag 101 attached to the club 201 did not return the interrogation signal. If a club was identified as present immediately subsequent to the current read/write step 520, the processor 312, through communicative coupling with the clock 311, enters a time stamp indicative of the time the club is determined to be not present. In other words, this is the first time the club is identified as not communicating back to the monitor and will be identified as not present starting from the time of this recognition. Alternatively, if the club was already missing, i.e., it was identified as missing subsequent to the current read/write step 520, no change is made to the previously-entered timestamp.

In step 522, for each club not reported as present, the display 303 is updated to indicate which club has been identified and the processor 312 determines the difference between the current time and any previously entered time stamps within the time-stamp fields 604 for that club. This difference in time will be referred to herein as a time “T” and indicates the length of time a club has been absent from the golf bag 103. It is envisioned that the display 303 will have an area showing the total number of RFID tags 101a-n being tracked and the number of RFID tags 101a-n that are currently missing. A smaller area of the screen can be dedicated to displaying messages, while other areas can be used to indicate battery and volume levels.

Next, in step 524, the processor 312 performs a comparative function and compares the value of T to a predetermined “out-of-bag” time limit. The out-of-bag time limit is a time that can be set by the user and dictates how long a club can reasonably be expected to be out of the bag before it is likely the club has inadvertently not been returned to the golf bag 103. If the predetermined out-of-bag time limit exceeds T, in step 526, the monitor 102 alerts the user that the club does not have an in-the-bag status.

In one embodiment of the present invention, the alert provided by the monitor can be an initial alert that is subtle, such as a flashing light and/or low intensity sound emitted from the monitor 102. The user can, in step 527, disable the alert. This is useful, for example, if the user is aware that the club is not responding to the interrogation signals. Once disabled, the processor updates the memory, in step 529, so that the continued discovery of the missing club is not responded to by an alert. If the alert is not disabled in step 527, the flow moves to step 528, where the amount by which “T” exceeds the out-of-bag time limit is monitored and, if the amount exceeds an alert limit, i.e., a second predetermined limit, in step 530 the monitor 102 transfers into a more aggressive alert state to indicate to the user that a club has been missing for pre-defined “long” period of time. The more aggressive alert can be, for example, an audible alert with a volume that is greater than the first alert, a different sound than the first alert, a vibration, or many others. Of course, the user is able to disable the alert in step 527 if the user does not want to or does not need to be reminded of the missing club. This may be the case when, for example, the user loaned the club to another golfer.

Motion Detection

FIG. 7 shows an exemplary process flow diagram illustrating the process steps of an embodiment of the present invention that utilizes a movement detector 307 to initiate an alert state of the monitor 102. The flow diagram of FIG. 7 closely matches the flow diagram presented in FIG. 5B and, for that reason, many of the steps retain the numbering shown in FIG. 5B. However, FIG. 7 illustrates the added feature of a constant motion detector monitoring process. More specifically, when a club has been determined to be missing (step 520), the process is forced to go through step 700 to determine whether motion has been detected. By always moving through step 700, whether or not the time “T” has been exceeded, if the motion detector 307 detects movement of the monitor 102 itself, the device is placed into a user-alert state. Of course, this alert can be a different type or intensity of an alert than the alert that is presented to the user upon first determining that “T” exceeds the out-of-bag time limit. The motion detector 307 can be, for example, an accelerometer. One such device is the ADXL330 available from ANALOG DEVICES. In accordance with exemplary embodiments of the present invention, the motion detector 307, in conjunction with the processor 312, is able to distinguish a knock from a continuous motion. For example, when the motion detector 307 senses motion for less than five seconds, the motion is defined as a knock, i.e., a sudden shake of the device. Alternatively, when the knocking persists continuously for more than five seconds, the movement is interpreted as an actual physical displacement of the monitor 102 and, typically, of the golf bag 103, indicating a movement of the monitor 102 from one location to another. This movement potentially signifies that the golfer is inadvertently leaving a club behind and the device functions to remind the golfer of this disadvantageous possibility.

According to an embodiment of the present invention, the inventory signal is transmitted in step 517 at variable power levels. More specifically, the transmitter 300 transmits at a first, i.e., lowest power setting, in step 517 and, if all the clubs are accounted for, the monitor goes into sleep mode, to save energy consumption, until the aforementioned “knock” or continuous motion happens. If, on the other hand, at least one club does not timely respond with its unique identifier, the second time the flow moves through step 517, the transmitter 300 transmits at a power level that is greater than the first power level. The increase in power can take place through several iterations and provides a mechanism for ensuring that the club is not present but possibly blocked from receiving the interrogation signal from the monitor 102. This process of interrogation at gradually increasing power results in efficient use of energy; power is expended only as needed, thus saving battery life.

The radio waves returned by an RFID tag 101 are relatively weak, especially if the tag is passive. It is one goal of the invention that the monitor 102 ensures, when a tag is missing, it is missing because the club has been removed and not because it was inaccurately detected as missing due a temporary and transient glitch in RF communication. To this end, the present invention utilizes another embodiment, referred to as a “bistatic” mode, which makes use the two separate antennas 301 and 306 shown in FIG. 3. The bistatic mode can be, but not necessarily be, combined with the increasing power method just described. In the separate first bistatic mode, the device 102 sends an interrogation signal with antenna 301 and receives responses with antenna 306. If all of the unique identifiers are received from the RFID tags 101a-n, the device 102 can go into a low power mode until it is time to transmit the next interrogation signal. However, if one or more clubs are determined to be missing, the monitor 102 can enter a second bistatic mode, where the processor causes the antennas 301, 306 to switch, i.e., reverse them. That is, antenna 306 is used to transmit and antenna 301 is used to receive responses. This reversal is non-communal, meaning only one antenna is used to transmit and only one is used to receive at one time. If no response is received after, for instance, ten tries with incrementally increasing power, the non-responding club is then defined as missing. A multiplexer can be used to connect a single antenna port of the monitor 102 to the two antennas 301, 306 and switches between the two antennas 301, 306 when needed. This process is particularly beneficial when the antennas 301, 306 are separated from each other by some distance.

In one embodiment of the present invention, the monitor 102 is able to call the user's cell phone to announce the possibility of a missing golf club. In yet another embodiment, the monitor 102 is able to temporarily disable the golf cart from leaving the area in which the club was last detected. This can be accomplished in many ways, such as wireless communication between the monitor 102 and the golf cart or the monitor 102 can be physically connected to the cart so that the detected out-of-bag time limit causes the monitor 102 to switch states, which sends a signal to the cart. Of course, the golfer can override the disablement of the cart if the club is intended to be or already identified as missing.

GPS

In accordance with additional embodiments of the present invention, the monitor 102 is operable to communicate with satellites that belong to the well-known Global Position System (GPS). GPS communication can be used for a variety of purposes, but mainly for determining terrestrial position of the monitor 102. For instance, by calculating the length of time a signal takes to travel from the satellite to the monitor 102, the monitor's distance from the satellite can be calculated. By using multiple satellites, a device's three-dimensional position on the earth can be determined with considerable accuracy: To utilize the GPS, the monitor 102 is provided with and uses a separate GPS antenna designed to communicate in the GPS frequency range. By adding the GPS functionality, the monitor 102 can (in addition to determining and identifying missing golf clubs and movement away from the area at which the club was determined missing) determine the location of each such event. By recording locations and occurrences and displaying them later to a user, the user can return to the exact spot the monitor 102 was present when the event occurred.

Club-Initiated Tracking

In accordance with a further embodiment of the present invention, tracking is initiated by transmission of a “removed” signal from the club 201. In this embodiment, each RFID tag 101 can be an “active” tag, i.e., has a battery, and can transmit signals autonomously, namely, when it is removed from the golf bag 103. This embodiment can be carried out, for example, by putting an antenna at the upper portion of the golf bag 103. This antenna would be in communication with the monitor 102. When a club is lifted out of the bag 103, the RFID tag 101 passes through the antenna, e.g., a loop antenna, which indicates to the monitor 102 that the club is removed from the golf bag 103.

If the RFID tag 101 is a passive device, the monitor 102 will assume that the first time the signal is received represents an indication that the club 201 is exiting the bag 103. Likewise, the second time the signal is received represents the club 201 being returned to the bag 103.

In yet an additional embodiment, the golf bag 103 can be provided with two antennas separated by a distance. By sensing the phase difference between a club detection of each antenna, the monitor 102 can determine whether the club 201 is being removed from, i.e., a lower antenna senses first and an upper antenna senses second, or the club 201 is being returned, i.e., the upper antenna senses first and the lower antenna senses second. It should be noted that this second embodiment can be utilized with any RFID tag 101, whether active or passive.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A system for monitoring an inventory of golf clubs, the system comprising:
a plurality of wireless transceivers, each wireless transceiver being attachable to a golf club and having a communicable unique identification code; and
a monitor having:
a transmitter;
a receiver;
a missing club indicator;
a memory having a set of expected identification codes stored therein; and
a processor communicatively coupled to the transmitter, the receiver, the missing club indicator, and the memory, and operable to:
cause the transmitter to transmit a first interrogation signal to the plurality of wireless transceivers, the first interrogation signal being an invitation for each of the plurality of wireless transceivers to respond with a respective signal that indicates each transceiver's unique identification code;
interpret the response signals received at the receiver to determine the unique identification code within the response signal;
compare the set of expected identification codes stored in the memory to each unique identification code received at the receiver;
determine an absence of reception of at least one unique identification code within the set of expected identification codes and set a first time stamp;
cause the transmitter to transmit a second interrogation signal to at least one of the plurality of transceivers having the at least one determined absent unique identification code, the second interrogation signal being an invitation for the transceiver having the determined absent unique identification code to respond with a signal that indicates the at least one determined absent unique identification code;
determine a continued absence at the receiver of the at least one determined absent unique identification code and set a second time stamp; and
activate the missing club indicator if an amount of time between the first and second time stamps exceeds a predetermined amount.

2. The system according to claim 1, wherein the processor is further operable to:
cause the transmitter to transmit an inventory signal to the plurality of wireless transceivers, the inventory signal being an invitation for the plurality of wireless transceivers to respond with a signal that indicates each transceiver's unique identification code;
cause the receiver to receive at least one response to the inventory signal; and
create the set of expected identification codes by storing in the memory each unique identifier code indicated by each of the at least one responses to the inventory signal.

3. The system according to claim 1, wherein:
the second interrogation signal is transmitted at a power level greater than a power level of the first interrogation signal.

4. The system according to claim 1, wherein the processor is further operable to:
cause the transmitter to transmit at least one intermediate interrogation signal between the transmission of the first interrogation signal and the transmission of the second interrogation signal.

5. The system according to claim 1, wherein the monitor further comprises:
a first antenna;
a second antenna; and
a switch selectively coupling the first antenna between the receiver and the transmitter, the selective coupling being non-communal with a coupling of the second antenna.

6. The system according to claim 1, further comprising:
a plurality of housings adapted for secured coupling to a golf club, each housing at least partially surrounding one of the plurality of wireless transceivers.

7. The system according to claim 6, wherein:
the secured coupling is to a grip end of the golf club.

8. The system according to claim 1, wherein the processor is further operable to:
determine a presence of reception of all unique identification codes within the set of expected identification codes; and
place the monitor into a low-power state.

9. The system according to claim 1, wherein the monitor:
is physically couplable to a golf bag; and
includes a motion detector communicatively coupled to the processor, wherein the processor is further operable to activate the missing club indicator upon receiving a signal from the motion detector indicating the presence of movement of the monitor.

10. The system according to claim 1, wherein at least a portion of the missing club indicator is physically separate from and in wireless communication with the monitor.

11. The system according to claim 1, wherein the monitor further comprises:
a display operable to display an identification of a missing club.

12. The system according to claim 11, wherein the display is physically separate from and in wireless communication with the monitor.

13. A method of monitoring an inventory of golf clubs, the method comprising:
transmitting a first interrogation signal from a transmitter to a plurality of wireless transceivers, each transceiver coupled to one of a corresponding plurality of golf clubs in a golf club set, the first interrogation signal being an invitation for each of the plurality of wireless transceivers to respond with a signal that indicates an identification code uniquely assigned to each transceiver;
receiving a plurality of response signals with a receiver, each response signal including the unique identification code assigned to the responding transceiver;
interpreting each of the plurality of response signals received at the receiver to identify the unique identification code within each signal;
comparing a set of expected identification codes stored in a memory to each unique identification code received at the receiver;
determining an absence of reception of at least one unique identification code within the set of expected identification codes and setting a first time stamp;
causing the transmitter to transmit a second interrogation signal to at least a one of the plurality of transceivers having the at least one determined absent unique identification code, the second interrogation signal being an invitation for the at least one of the plurality of transceivers having the determined absent unique identification code to respond with a signal that indicates the at least one determined absent unique identification code; and
in response to:
determining a continued absence of the at least one determined absent unique identification code and setting a second time stamp; and
determining that the difference between the first and second time stamps exceeds a predetermined amount,
activating a missing club indicator.

14. The method according to claim 13, further comprising:
transmitting an inventory signal to the plurality of wireless transceivers, the inventory signal being an invitation for the plurality of wireless transceivers to respond with a signal that indicates each transceiver's unique identification code;
receiving at least one response to the inventory signal; and
creating the set of expected identification codes by storing in the memory each unique identifier code indicated by each of the at least one responses to the inventory signal.

15. The method according to claim 13, further comprising:
transmitting the first interrogation signal at a first power level; and
transmitting the second interrogation signal at a second power level greater than the first power level.

16. The method according to claim 13, further comprising:
transmitting at least one intermediate interrogation signal between the transmission of the first interrogation signal and the transmission of the second interrogation signal.

17. The method according to claim 13, wherein:
the transmitter and the receiver are part of a transceiver that includes:
a first antenna;
a second antenna; and
a switch selectively coupling the first antenna between the receiver and the transmitter, the selective coupling being non-communal with a coupling of the second antenna.

18. The method according to claim 1, further comprising:
in response to determining the continued absence of the at least one determined absent unique identification code:
monitoring motion of a golf bag with a motion detector; and
activating the missing club indicator upon detecting motion.

19. A monitor for monitoring an inventory of golf clubs, the monitor comprising:
a transceiver;
a missing club indicator;
a memory having a set of expected identification codes stored therein; and
a processor communicatively coupled to the transceiver, the missing club indicator, and the memory, and operable to:
cause the transceiver to transmit a first interrogation signal to a plurality of wireless transceivers, the first interrogation signal being an invitation for each of the plurality of wireless transceivers to respond with a signal that indicates each transceiver's unique identification code;
interpret each the response signals received at the transceiver to determine the unique identification code within each response signal;
compare the set of expected identification codes stored in the memory to each unique identification code received at the receiver;
determine an absence of reception of at least one unique identification code within the set of expected identification codes;
cause the transceiver to transmit a second interrogation signal to at least a one of the plurality of transceivers having the at least one determined absent unique identification code, the second interrogation signal being an invitation for the transceiver having the determined absent unique identification code to respond with a signal that indicates the at least one determined absent unique identification code;
determine a continued absence at the transceiver of the at least one determined absent unique identification code; and
activate the missing club indicator if an amount of time between the determining the absence and the determining the continued absence exceeds a predetermined amount.

20. The monitor according to claim 19, wherein the monitor further comprises:
a motion detector communicatively coupled to the processor, wherein the processor is further operable to activate the missing club indicator upon receiving a signal from the motion detector indicating the presence of movement of the monitor.
